(19) United States
(12) Patent Application Publication
(10) Pub. No.: US 2009/0228923 A1
(43) Pub. Date: Sep. 10, 2009

(54) METHOD AND APPARATUS FOR EXECUTING APPLICATION

(75) Inventors: Sang-gyu LEE, Seoul (KR); Seung-bum CHUNG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/204,244

(22) Filed: Sep. 4, 2008

(30) Foreign Application Priority Data
Mar. 4, 2008 (KR) 10-2008-0020069

(51) Int. Cl. H04N 5/445; G06F 21/00; G06F 3/00

(52) U.S. Cl. 725/38; 726/22

(57) ABSTRACT

Provided is a method of executing an application. In the method, an application is received, whether the received application is one of the applications verified as being not altered is determined based on verification information identifying the applications verified as being not altered, and then, the received application is selectively executed according to the determination.

### CROSS-REFERENCE TO RELATED PATENT APPLICATIONS

This application claims the benefit of Korean Patent Application No. 10-2008-0020069, filed on Mar. 4, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to executing an application.

2. Description of the Related Art

When a digital broadcast is received, not only content consisting of audio/video data is received but also an application to be used for reproduction of the content is received. In this case, the application may be either a user interface for reproducing the content or a program that provides an additional service.

If an application received together with content is maliciously altered by a third person, information regarding the content and an apparatus for executing the application may be leaked.

In order to prevent this problem, a technique of verifying whether an application has been altered and of controlling the application to be executed only when it has not been altered has been proposed.

FIG. 1 is a flowchart illustrating a conventional method of executing an application. In operation 110, an application is received.

In operation 120, whether the application has been altered is verified.

In operation 130, if it is verified that the application has not been altered, the application is executed.

In this case, as described above, the application may be executed either as a user interface for content reproduction or in order to provide an additional service.

Alternatively, a preparation for execution of the application may be conducted between operations 120 and 130. For example, conversion of the application into a format that can be executed in memory may further be performed.

If a user changes channels while watching of a digital broadcast on a digital television (DTV) via one channel, the DTV stops execution of an application that is being currently executed, and performs unloading in which all data related to the application is removed from memory. Next, the DTV receives content and an application related to a new channel, verifies the application related to the new channel, and selectively executes the application related to the new channel according to the result of the verification.

If the user performs a channel change again in order to return to the previous channel, unloading related to the application regarding the new channel is performed. Then, the application related to the previous channel is verified again and is then selectively executed according to the result of the verification.

As described above, conventionally, even though verification increases the load on a central processing unit (CPU) and memory, verification is performed again on an application that has already been verified, thereby increasing the load on the CPU and the memory.

### SUMMARY OF THE INVENTION

The present invention provides a method and apparatus for executing an application while skipping verification unnecessary to the execution of the application.

According to an aspect of the present invention, there is provided a method of executing an application, the method comprising receiving an application; determining whether the received application is one of applications verified as being not altered, based on verification information identifying the applications verified as being not altered; and selectively executing the application according to the determination.

The verification information may include identifiers of the applications verified as being not altered when the applications have previously been received.

The verification information may further comprise at least one of identifiers of channels via which the applications are respectively transmitted, a checksum of each of the applications, and version information of the applications verified as being not altered.

If it is determined that the received application is one of the applications verified as being not altered, the selective executing of the application may include executing the received application.

If it is determined that the received application is one of the applications verified as being not altered, the selective executing of the application may include determining whether the received application is identical to the corresponding application verified as being not altered, based on checksums included in the verification information. The received application may be selectively executed according to the determination as to whether the received application is identical to the corresponding application verified as being not altered.

If it is determined that the received application is not one of the applications verified as being not altered, the selectively executing of the application may include verifying whether the received application has been altered. The received application may be selectively executed according to a result of verifying whether the received application has been altered.

According to another aspect of the present invention, there is provided an apparatus for executing an application, the apparatus comprising a receiving unit receiving an application; a determination unit determining whether the received application is one of applications verified as being not altered, based on verification information identifying the applications verified as being not altered; and an execution unit selectively executing the received application according to the determination of the determination unit.

The apparatus may further include a verification unit verifying whether the received application has been altered, when it is determined that the received application is not one of the applications verified as being not altered. The execution unit selectively may execute the received application according to the verification of the verification unit.

According to another aspect of the present invention, there is provided a computer readable recording medium having recorded thereon a computer program for executing a method of executing an application, the method including receiving an application; determining whether the received application is one of applications verified as being not altered, based on verification information identifying the applications verified as being not altered; and selectively executing the application according to the determination.

### BRIEF DESCRIPTION OF THE DRAWINGS

The above and other features and aspects of the present invention will become more apparent by describing in detail exemplary embodiments thereof with reference to the attached drawings in which:

FIG. 1 is a flowchart illustrating a conventional method of executing an application;

FIG. 2 is a block diagram of an apparatus for executing an application according to an embodiment of the present invention;

FIG. 3 is a flowchart illustrating a method of creating verification information according to an embodiment of the present invention;

FIG. 4 is a flowchart illustrating a method of executing an application according to an embodiment of the present invention; and

FIG. 5 is a flowchart illustrating an example of an application of a method of executing an application according to an embodiment of the present invention.

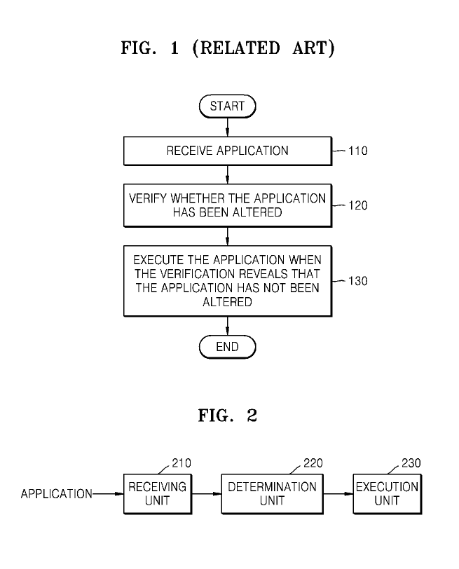

### DETAILED DESCRIPTION OF THE INVENTION

Hereinafter, exemplary embodiments of the present invention will be described in detail with reference to the accompanying drawings.

FIG. 2 is a block diagram of an apparatus for executing an application according to an embodiment of the present invention. Referring to FIG. 2, the application includes a receiving unit 210, a determination unit 220, and an execution unit 230.

The receiving unit 210 receives an application.

The determination unit 220 determines whether the received application is one of applications verified as not having been altered, based on verification information regarding applications that were verified as not having been altered.

Here, the verification information contains identifiers of applications that were verified as not having been altered when they previously were received.

For example, the determination unit 220 may determine whether the received application is one of the applications verified as not having been altered by comparing the identifier of the received application with those of the applications verified as not having been altered, which are included in the verification information.

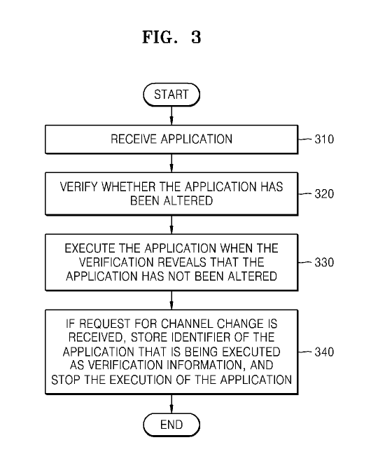

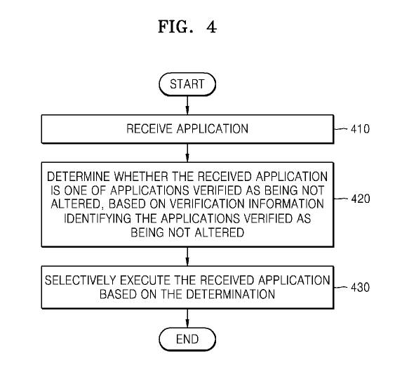

FIG. 3 is a flowchart illustrating a method of creating verification information according to an embodiment of the present invention. Referring to FIG. 3, in operation 310, an application is received.

In operation 320, whether the received application has been altered is verified.

In operation 330, if the verification reveals that the application has not been altered, the application is executed.

In operation 340, if a request for a channel change from a current channel to another channel is received, an identifier of the application that is currently being executed is stored as verification information, and execution of the current application is stopped.

For example, if a digital television (DTV) receives a request for a channel change from a channel A to a channel B during reproduction of content A with an application A received via the channel A, the DTV stores an identifier of the application A as verification information, and stops execution of the application A. In this case, the stopping of the execution of the application A may precede the storing of the verification information. The verification information may include at least one of identifiers of channels via which applications verified as not having been altered were transmitted, a checksum of each of the applications verified as not having been altered, and version information of the applications verified as not having been altered.

For example, as described above, the determination unit 220 of FIG. 2 may compare an identifier of a received application with those of applications verified as not having been altered, which are included in verification information, determine whether the received application was received via the same channel used to transmit an application verified as not having been altered, and then determine the received application as not having been altered only when the received application was received via the same channel.

Alternatively, the determination unit 220 may further determine whether the received application is the same as any one of the applications verified as not having been altered, which are included in the verification information, based on a checksum or version information of each of the applications verified as not having been altered.

For example, even if a received application has the same identifier and channel number as an application verified as not having been altered, the determination unit 220 may determine that these applications are not identical to each other when their checksum and version information are not the same.

The execution unit 230 selectively executes the received application according to the determination of the determination unit 220.

That is, if the determination of the determination unit 220 reveals that the received application is one of the applications verified as not having been altered, the execution unit 230 executes the received application.

However, if the determination of the determination unit 220 reveals that the received application is not one of the applications verified as not having been altered, that is, that whether the received application has been altered cannot be determined, then the execution unit 230 does not execute the received application and verify whether it has been altered. In this case, the execution unit 230 executes the received application only when the verification reveals that the received application is one of the applications verified as not having been altered.

Here, the verification can be performed using a hash value, electronic signature, or message authentication code (MAC) for the received application. The hash value, the electronic signature, and the MAC may be received when the application is received, or may be received additionally when verification is considered necessary.

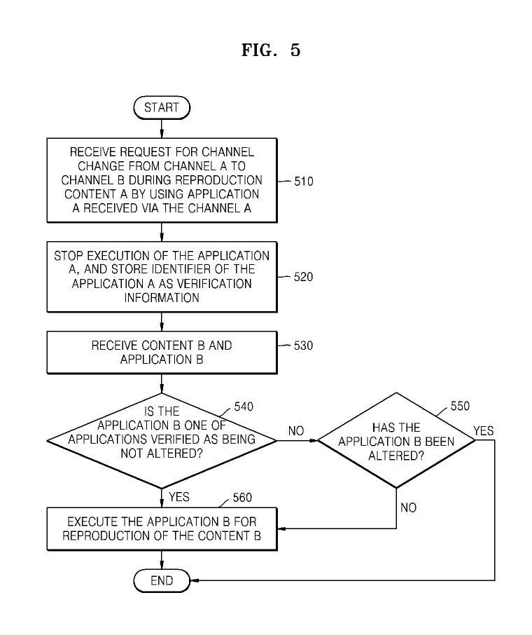

An apparatus for executing an application according to an embodiment of the present invention may further include a verification unit (not shown) that verifies whether a received application has been altered when the application is suspected of having been altered. FIG. 4 is a flowchart illustrating a method of executing an application according to an embodiment of the present invention. In operation 410, an application is received.

In operation 420, whether the received application is one of applications verified as not having been altered is determined, based on verification information identifying the applications verified as not having been altered.

In operation 430, the received application is selectively executed based on the determination made in operation 420.

FIG. 5 is a flowchart illustrating an example of an application of a method of executing an application according to an embodiment of the present invention.

In operation 510, a DTV receives a request for a channel change from a channel A to a channel B from a user input device during reproduction of content A with an application A received via the channel A.

In operation 520, the DTV stops execution of the application A, and stores an identifier of the application A as verification information, in response to the request.

The verification information may further include information indicating that the application A was transmitted via the channel A, as well as a checksum and version information of the application A.

In operation 530, the DTV receives content B and an application B via the channel B.

In operation 540, the DTV determines whether the application B is one of applications verified as not having been altered, based on the verification information.

For example, whether the application B is one of the applications verified as not having been altered may be determined by checking whether an identifier of the application B is included in the verification information as an identifier of an application verified as not having been altered.

In operation 550, if it is determined in operation 540 that the application B is not one of the applications verified as not having been altered in the verification information, whether the application B has been altered is verified since it is unclear as to whether the application B has been altered.

In operation 560, if it is determined in operation 540 that the application B is one of the applications verified as not having been altered or if it is determined in operation 550 that the application B has not been altered, the application B is executed in order to reproduce the content B.

The above embodiments of the present invention can be embodied as a computer program. The computer program may be executed using a general digital computer via a computer-readable medium. Examples of the computer-readable medium include a magnetic recording medium (a ROM, a floppy disk, a hard disc, etc.), and an optical recording medium (a CD-ROM, a DVD, etc.). Other examples of the computer-readable medium in alternative embodiments may include carrier waves (such as in transmission over the Internet).

According to the above embodiments of the present invention, it is possible to skip a verification operation that is unnecessary to execute an application.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A method of executing an application, the method comprising:
receiving an application;
determining whether the received application is one of applications verified as not having been altered, based on verification information identifying the applications verified as not having been altered; and
selectively executing the application according to the determination.

2. The method of claim 1, wherein the verification information comprises identifiers of the applications verified as not having been altered when the applications have been previously received.

3. The method of claim 2, wherein the verification information further comprises at least one of identifiers of channels through which the applications are respectively transmitted, a checksum of each of the applications, and version information of the applications verified as not having been altered.

4. The method of claim 1, wherein if it is determined that the received application is one of the applications verified as not having been altered, the selective executing of the application comprises executing the received application.

5. The method of claim 4, wherein if it is determined that the received application is one of the applications verified as not having been altered, the selective executing of the application comprises determining in a determination, whether the received application is identical to a corresponding application verified as not having been altered, based on checksums included in the verification information,
wherein the received application is selectively executed according to the determination as to whether the received application is identical to the corresponding application verified as not having been altered.

6. The method of claim 1, wherein if it is determined that the received application is not one of the applications verified as not having been altered, the selectively executing of the application comprises verifying whether the received application has been altered,
wherein the received application is selectively executed according to a result of verifying whether the received application has been altered.

7. An apparatus for executing an application, the apparatus comprising:
a receiving unit which receives an application;
a determination unit which determines in a determination, whether the received application is one of applications verified as not having been altered, based on verification information identifying the applications verified as not having been altered; and
an execution unit selectively executes the received application according to the determination of the determination unit.

8. The apparatus of claim 7, wherein the verification information comprises identifiers of the applications verified as not having been altered when the applications have been previously received.

9. The apparatus of claim 8, wherein the verification information further comprises at least one of identifiers of channels through which the applications are respectively transmitted, a checksum of each of the applications, and version information of the applications verified as not having been altered.

10. The apparatus of claim 7, wherein if it is determined that the received application is one of the applications verified as not having been altered, the execution unit executes the received application.

11. The apparatus of claim 10, wherein if it is determined that the received application is one of the applications verified as not having been altered, the determination unit further determines in a determination, whether the received application is identical to a corresponding application verified as not having been altered, based on checksums included in the verification information, and
the execution unit selectively executes the received application according to the determination as to whether the received application is identical to the corresponding application verified as not having been altered

12. The apparatus of claim 7, further comprising a verification unit which verifies whether the received application has been altered, when it is determined that the received application is not one of the applications verified as not having been altered,
wherein the execution unit selectively executes the received application according to the verification of the verification unit.

13. A computer readable recording medium having recorded thereon a computer program for executing the method of executing an application, the method comprising:
receiving an application;
determining whether the received application is one of applications verified as not having been altered, based on verification information identifying the applications verified as not having been altered; and
selectively executing the application according to the determination.

14. A method of executing an application, the method comprising:
first receiving an application;
verifying that the first received application has not been altered and generating verification information based on the verifying;
second receiving the application previously received in the first receiving; and
determining whether the second received application has not been altered based on the verification information without verifying the second received application.

15. The method of claim 14, wherein the first received application and the second received application are received through at least one of a plurality of digital television (DTV) channels.

16. The method of claim 15, wherein the first received application is received through a first DTV channel and is executed, if the first received application is verified to not have been altered, and the method further comprises:
switching from the first DTV channel to another channel and stopping the execution of the first received application; and
switching from the another channel to a second channel so that the second received application is received through the second channel.

17. The method of claim 16, wherein the first and the second channels are the same.
